(19) United States
(12) Patent Application Publication
(10) Pub. No.: US 2007/0208507 A1
(43) Pub. Date: Sep. 6, 2007

(54) Current position sensing system, map display system and current position sensing method

(75) Inventor: Masayuki Gotoh, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/709,273

(22) Filed: Feb. 22, 2007

(30) Foreign Application Priority Data
Mar. 3, 2006 (JP) 2006-057835

(51) Int. Cl. G01C 21/32

(52) U.S. Cl. 701/210; 701/208

(57) ABSTRACT

When information of a target, with which position information is associated, is extracted from map information, a relative position of a measurement subject, which is sensed by a radar, is obtained. Next, an absolute position of the measurement subject is estimated based on a current position of a vehicle, which is sensed through a GPS receiver, and a relative position of the measurement subject. When a distance between the measurement subject and the target is less than a predetermined threshold value, the measurement subject, which is sensed by the radar, is recognized as the target. An absolute position of the vehicle is computed based on the position information of the target and the relative position of the target. The position of the vehicle, which is sensed by the GPS receiver, is corrected to the computed absolute position.

### CROSS REFERENCE TO RELATED APPLICATION

This application is based on and incorporates herein by reference Japanese Patent Application No. 2006-57835 filed on Mar. 3, 2006.

### BACKGROUND OF THE INVENTION

1. Field of the Invention

The present invention relates to a current position sensing system, a map display system and a current position sensing method.

2. Description of Related Art

A known current position sensing system, which can sense a current position of a movable entity, such as a vehicle, includes a global positioning system (GPS). Such a current position sensing system is often installed in a map display system of, for example, a car navigation system.

The map display system senses a current position of, for example, a vehicle through the current position sensing system and displays a map, which corresponds to the sensed current position, on a display device.

For instance, Japanese Unexamined Patent Publication JP-A-2005-121707 discloses such a map display system. In this map display system, when it is sensed that the vehicle is traveling along a new road, which is not registered in prestored map data, this new road is added to the map data to update the map data.

However, in the current position sensing system (e.g., the GPS), which is installed in the above map display system, only a current approximate position can be measured, and there is a possibility of generating a measurement error of about 50 m at most. Thus, when a driver of the vehicle watches the above map display system at the time of driving the vehicle, the displayed image on the map display system often significantly differs from the actual surround scene. Thus, there is a high possibility of overlooking some targets, such as a building or an intersection.

Furthermore, in the map display system recited in Japanese Unexamined Patent Publication JP-A-2005-121707, even if the newly sensed road is added to the map data, the accuracy of the map data cannot be guaranteed due to the relatively large measurement error of the current position sensing system.

### SUMMARY OF THE INVENTION

The present invention addresses or alleviates at least one of the above disadvantages.

According to one aspect of the present invention, there is provided a current position sensing system for sensing a current position of a movable entity. The current position sensing system includes a current position sensing means, a map information storing means, a relative position sensing means, a target extracting means, an obtaining means, an estimating means, a recognizing means and a correcting means. The map information storing means is for storing map information that includes information of a target, with which position information that indicates a latitude and a longitude of the target is associated. The relative position sensing means is for sensing a relative position of a measurement subject with respect to the movable entity. The target extracting means is for extracting the information of the target from the map information when the target is located within a predetermined sensing range where the measurement subject is sensible by the relative position sensing means at a time of operating the relative position sensing means at the current position sensed by the current position sensing means. The obtaining means is for obtaining the relative position of the measurement subject, which is sensed by the relative position sensing means when the information of the target is extracted by the target extracting means. The estimating means is for estimating an absolute position of the measurement subject based on the current position of the movable entity, which is sensed by the current position sensing means, and the relative position of the measurement subject, which is obtained by the obtaining means. The recognizing means is for recognizing the measurement subject, which is sensed by the relative position sensing means, as the target, which is extracted by the target extracting means, when a distance between the measurement subject, the absolute position of which is estimated by the estimating means, and the target, which is extracted by the target extracting means, is less than a predetermined threshold value. The correcting means is for correcting the current position of the movable entity, which is sensed by the current position sensing means, to an absolute position of the movable entity, wherein the absolute position of the movable entity is computed based on the position information of the target, which is recognized by the recognizing means, and the relative position of the target, which is obtained by the obtaining means.

According to another aspect of the present invention, there is provided a map display system, which includes the above current position sensing system and a display device. The display device displays a map, which corresponds to the current position of the movable entity that is sensed by the current position sensing system.

According to another aspect of the present invention, there is also provided a current position sensing method for sensing a current position of a movable entity upon execution of the current position sensing method in a current position sensing system, which includes: a current position sensing means for sensing an approximate current position of the movable entity; a map information storing means for storing map information that includes information of a target, with which position information that indicates a latitude and a longitude of the target is associated; and a relative position sensing means for sensing a relative position of a measurement subject with respect to the movable entity. In the current position sensing method, the information of the target is extracted from the map information when the target is located within a predetermined sensing range where the measurement subject is sensible by the relative position sensing means at a time of operating the relative position sensing means at the current position sensed by the current position sensing means. Then, there is obtained the relative position of the measurement subject, which is sensed by the relative position sensing means when the information of the target is extracted through the extracting of the information of the target. An absolute position of the measurement subject is estimated based on the current position of the movable entity, which is sensed by the current position sensing means, and the relative position of the measurement subject, which is obtained through the obtaining of the relative position of the measurement subject. Then, there is recognized the measurement subject, which is sensed by the relative position sensing means, as the target, which is extracted through the extracting of the information of the target, when a distance between the measurement subject, the absolute position of which is estimated through the estimating of the absolute position of the measurement subject, and the target, which is extracted through the extracting of the information of the target, is less than a predetermined threshold value. Then, there is corrected the current position of the movable entity, which is sensed by the current position sensing means, to an absolute position of the movable entity. The absolute position of the movable entity is computed based on the position information of the target, which is recognized through the recognizing of the measurement subject, and the relative position of the target, which is obtained through the obtaining of the relative position of the measurement subject.

### BRIEF DESCRIPTION OF THE DRAWINGS

The invention, together with additional objectives, features and advantages thereof, will be best understood from the following description, the appended claims and the accompanying drawings in which:

FIG. 1 is a block diagram showing a schematic structure of a map information collection/delivery system according to an embodiment of the present invention;

FIG. 2 is a flowchart of a current position sensing operation executed by a navigation ECU according to the embodiment;

FIG. 3 is a flowchart showing a position correcting operation of the current position sensing operation;

FIGS. 4A and 4B are descriptive views for describing details of the current position sensing operation;

FIG. 5 is a flowchart showing a road identifying operation of the position correcting operation; and

FIG. 6 is a flowchart showing an data transmitting operation executed by the navigation ECU.

### DETAILED DESCRIPTION OF THE INVENTION

An embodiment of the present invention will be described with reference to the accompanying drawings.

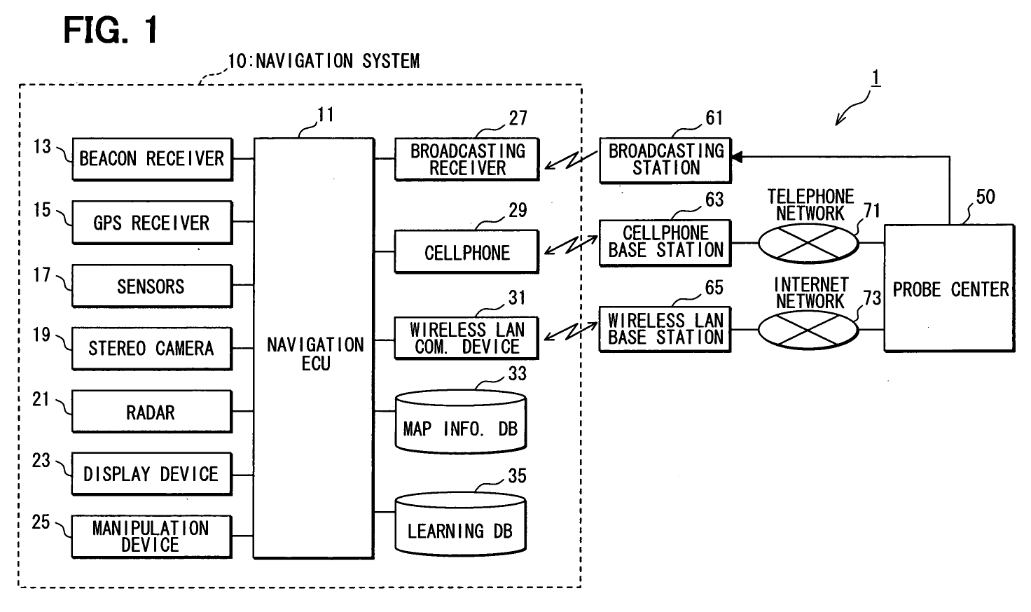

FIG. 1 is a block diagram showing a schematic structure of a map information collection/delivery system. As shown in FIG. 1, the map information collection/delivery system 1 includes a navigation system 10, a probe center 50 and a communication facility. The navigation system 10 is provided to a vehicle, and the probe center 50 is provided outside of the vehicle. The communication facility is used to communicate between the navigation system 10 and the probe center 50.

Here, the probe center 50 collects data with respect to map information (map data) from the navigation system 10 of each corresponding vehicle. When the map information is renewed based on the collected data, the probe center 50 transmits corresponding data (e.g., new map information) to the vehicle.

The communication facility, which is used to communicate between the navigation system 10 and the probe center 50, includes a cellphone base station 63, a wireless LAN base station 65 and a broadcasting station 61. The cellphone base station 63 is used to implement two-way communication thorough a telephone network 71. The wireless LAN base station 65 is used to implement two-way communication through an internet network 73. The broadcasting station 61 transmits airwave together with data, which is received from the probe center 50.

The navigation system 10 includes a navigation electronic control unit (ECU) 11 as its main component. The navigation system 10 retrieves map information from a map information database 33 and displays the retrieved map information on a display device 23 (e.g., a color liquid crystal display).

Map information is prestored in the map information database 33. The map information includes information of a target, which is associated with position information that indicates a latitude and a longitude of the target.

Furthermore, besides the map information database 33 and the display device 23 described above, the navigation system 10 also includes a light beacon receiver 13, a GPS receiver 15, various sensors 17 (e.g., a gyro, a vehicle speed sensor and an acceleration sensor), a stereo camera 19, a radar 21, a manipulation device (e.g., a keyboard, a touch panel, switches or the like) 25, a broadcasting receiver 27, a cellphone 29, a wireless LAN communication device 31 and a learning database 35.

The light beacon receiver 13 receives beacon signals from light beacon transmitters (not shown), which are arranged one after another along a load. The beacon signal contains traffic information (e.g., traffic jam information, parking lot vacancy information). When the navigation ECU 11 receives the beacon signal, the navigation ECU 11 displays the traffic information over the map information on the display device 23.

The GPS receiver 15 receives GPS signals from GPS satellites and senses a current position of the vehicle based on the received GPS signals.

When the GPS signals cannot be correctly received from the GPS satellites, or when the current position of the vehicle cannot be accurately sensed, the sensors 17 are used to estimate the current position of the vehicle.

The stereo camera 19 may include two cameras, which are provided on a left front side and a right front side, respectively, of the vehicle to capture an image of an subject (hereinafter, referred to as an imaging subject). The navigation ECU 11 synthesizes (or merges) captured images, which are captured by the two cameras of the stereo camera 19. Based on the synthesized image, the navigation ECU 11 can sense a distance from the vehicle to the imaging subject and a direction of the imaging subject relative to the vehicle.

The radar 21 is positioned in a front center of the vehicle and is formed as, for example, a laser radar. The radar 21 outputs and swings a directional beam in a left-to-right direction and senses a reflected beam, which is reflected from a measurement subject. In this way, the radar 21 measures a distance from the vehicle to the measurement subject. The navigation ECU 11 monitors an output angle of the beam outputted from the radar 21 and the distance from the vehicle to the measurement subject. Based on the output angle of the beam and the distance from the vehicle to the measurement subject, the navigation ECU 11 recognizes a relative position of the measurement subject and a shape of the measurement subject.

The broadcasting receiver 27, the cellphone 29 and the wireless LAN communication device 31 are used to perform data communication relative to the probe center 50.

The broadcasting receiver 27 is also constructed to receive normal broadcast programs (TV programs and radio programs). The cellphone 29 may be formed integrally with the navigation system 10. Alternatively, the cellphone 29 may be an ordinary cellphone, which is separable from the navigation system 10.

The learning database 35 is used as a storage space, which stores information that is obtained at the time of traveling of the vehicle.

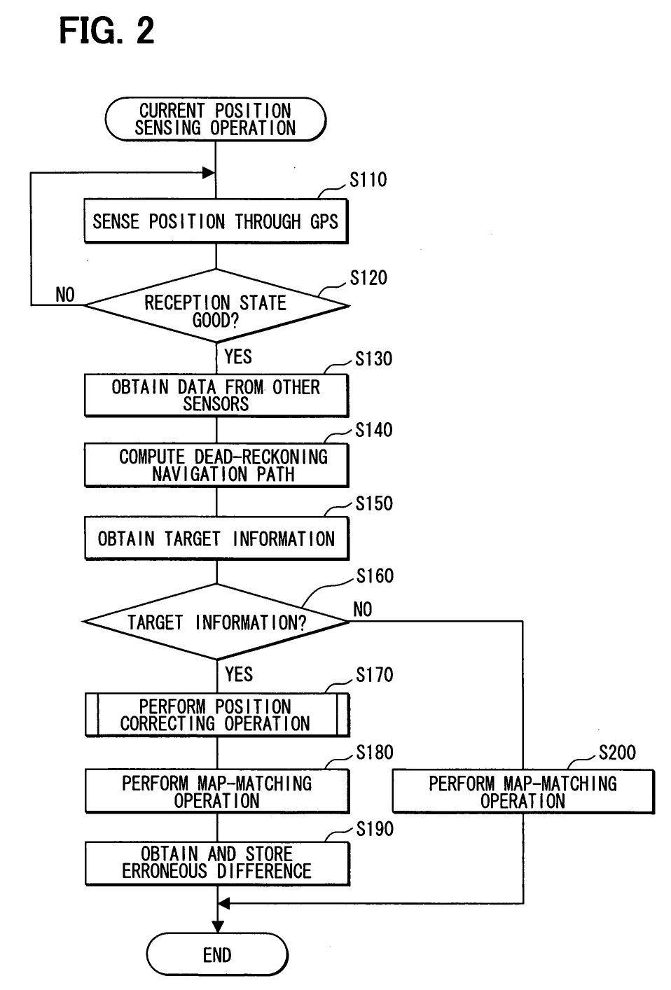

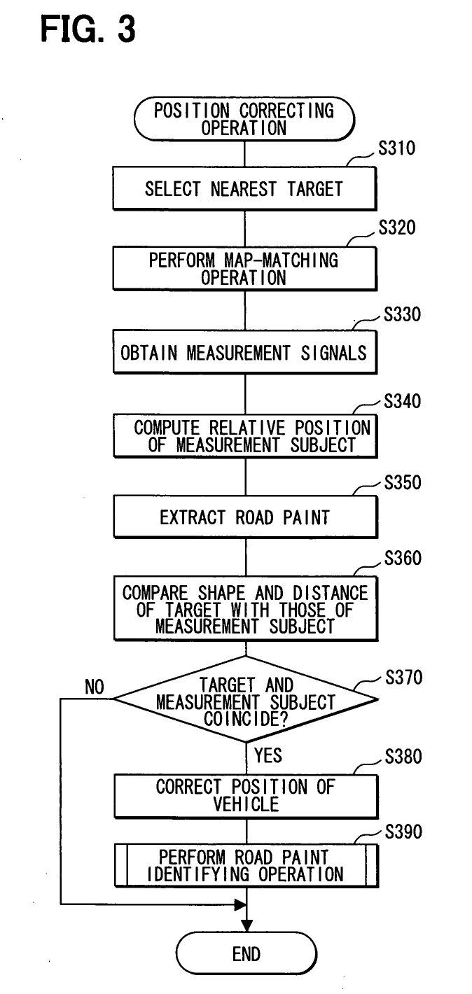

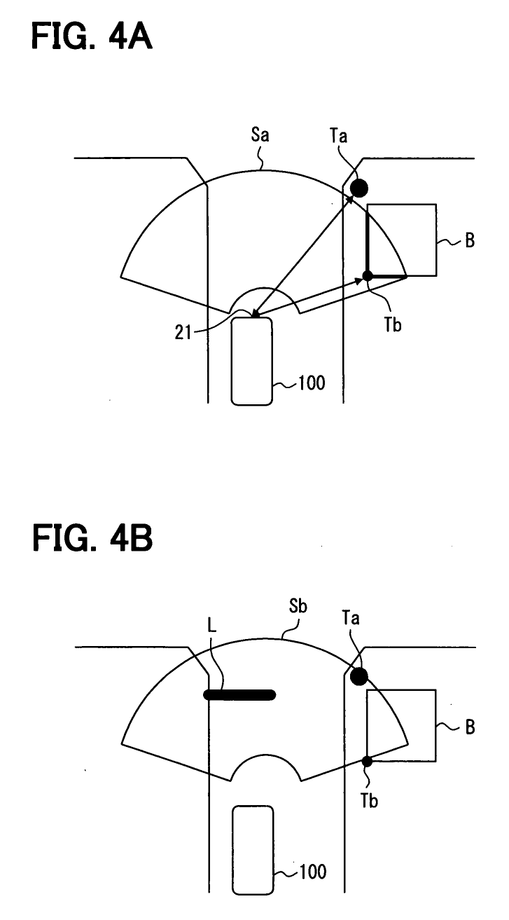

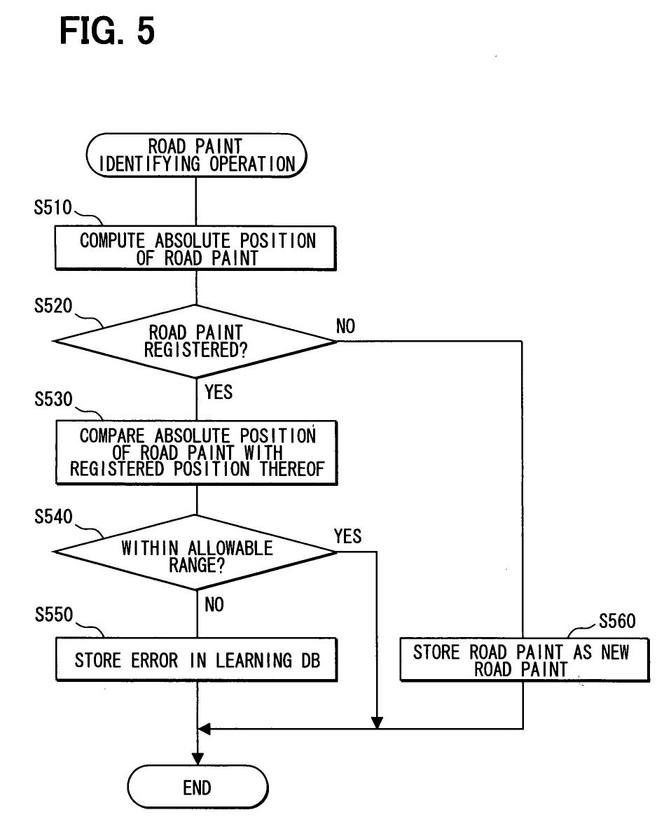

A current position sensing operation, which is executed in the navigation system 10 to sense the current position of the vehicle, will be described with reference to FIGS. 2 to 5. FIG. 2 is a flowchart showing the current position sensing operation, which is executed by the navigation ECU 11. FIG. 3 is a flowchart showing a position correcting operation (position calibrating operation) of the current position sensing operation. FIGS. 4A and 4B are descriptive diagrams for describing details of the position correcting operation. FIG. 5 is a flowchart showing a road paint identifying operation of the position correcting operation.

In the current position sensing operation shown in FIG. 2, an approximate position of the vehicle is measured through, for example, the GPS receiver 15, and thereafter the measured current position of the vehicle is corrected, i.e., calibrated more accurately.

Specifically, as shown in FIG. 2, the approximate current position of the vehicle is sensed through the GPS receiver 15 at step S110.

Then, at step S120, it is determined whether a reception state of the GPS signals, which are received by the GPS receiver 15 from the GPS satellites, is good. The determination of whether the reception state of the GPS signals is good or not is made based on satellite position information, such as almanac information (approximate orbit information of the GPS satellites) and the number of the useful GPS satellites.

When it is determined that the reception state of the GPS signals from the GPS satellites is good at step S120, the navigation ECU 11 proceeds to step S130. In contrast, when it is determined that the reception state of the GPS signals from the GPS satellites is not good at step S120, the navigation ECU 11 returns to step S110.

At step S130, the navigation ECU 11 obtains various types of data, which are sensed by the sensors 17. The data, which is obtained here, is the data that is received from, for example, the gyro, the vehicle speed sensor and the acceleration sensor and that is used to estimate the current position of the vehicle. The operation of step S130 may be performed in parallel with the operation of step S110.

Next, at step S140, a dead-reckoning navigation path is computed. Here, a probable travel path, along which the vehicle will probably travel, is estimated as the dead-reckoning navigation path based on the information from the sensors 17 (e.g. the gyro, the vehicle speed sensor), the information of road configurations, and information of a previous measurement location. Through this operation, the orientation of the vehicle and the position of the vehicle can be more precisely determined. The dead-reckoning navigation path, which is computed at step S140, is stored in the learning database 35.

The operation of step S140 (the operation for computing the dead-reckoning navigation path) is described in JP-A-2004-286724 (corresponding to U.S. Pat. No. 7,096,116 B2 contents of which is incorporated herein by reference) and therefore will not be described further for the sake of simplicity.

Furthermore, in the operation of step S140, the image, which is captured by the stereo camera 19, may be analyzed, or the radar 21 (e.g., the laser radar) may be used to sense a distance from the vehicle to the measurement subject. Thereby, a road lane, on which the current position of the vehicle is placed, may be sensed, or a relative location of the current position of the vehicle with respect to a forthcoming road curve may be sensed. Then, this information may be used to compute the dead-reckoning navigation path.

Now, with reference to FIG. 4A, there will be described a case where the measurement subject is sensed through use of the radar 21 in the operation of step S140.

As shown in FIG. 4A, a sensing area Sa, in which the measurement subject can be sensed through use of the radar 21, is formed in front of the vehicle 100. In the case of FIG. 4A, a building B, with which corresponding position information is associated, is located on a right front side of the vehicle 100, and a portion of this building B is in the sensing area.

In this state, when the building B (the measurement subject) is sensed through the radar 21, a portion (indicated by a bold line in FIG. 4A) of an outline of the building B is sensed. Also, at this time, a direction of the building B from the vehicle 100 and a distance from the vehicle 100 to the building B can be sensed, that is, a relative position of the building B with respect to the vehicle 100 can be sensed. In FIG. 4A, each of points Ta, Tb is a target, position information of which is available or with which position information that indicates a latitude and a longitude thereof is associated in the map information. More specifically, the point Ta is a utility pole, and the point Tb is a corner of the building B.

Returning to FIG. 2, at step S150, information (target information) of target(s), which is within a predetermined range (e.g., a range of a 30 m radius) around the approximate position of the vehicle 100 identified at step S140, is obtained from the map information (the map information database 33). Here, the exact latitude and longitude information (with the absolute position accuracy on the order of several centimeters) is also obtained and is stored in a memory (e.g., an RAM).

Then, at step S160, it is determined whether the target information has been obtained at step S150 by checking the memory (e.g., the RAM). When it is determined that the target information has been obtained at step S160, the navigation ECU 11 proceeds to step S170. At step S170, a position correcting operation for more accurately sensing the current position of the vehicle is executed. Then, the navigation ECU 11 proceeds to step S180. In contrast, when it is determined that the target information has not been obtained at step S160, the navigation ECU 11 proceeds to step S200.

At each of steps S180 and S200, a corresponding map-matching operation is performed. The map-matching operation is an operation that corrects and thereby places the position of the vehicle on a predetermined line (a nearest line, or a line of a highest priority), which is set as the travel path of the vehicle 100 in the map information. In the map-matching operation at step S180, the position of the vehicle, which is computed through the position correcting operation (step S170), is used as a reference. In contrast, in the map-matching operation at step S200, the position of the vehicle, which is computed at step S140 based the dead-reckoning navigation path, is used as a reference.

Details of the map-matching operation may be referred to, for example, JP-A-2006-003166.

Next, after completion of the operation at step S180, the navigation ECU 11 proceeds to step S190. In contrast, after completion of the operation at step S200, the navigation ECU 11 terminates the current position sensing operation.

At step S190, the position of the vehicle 100 after the position correcting operation (step S170) and the position of the vehicle after the map-matching operation (step S180) are both retrieved. Then, an erroneous difference (an error) between the map information and the actual position of the vehicle is obtained, and the value of this erroneous difference (the error) is stored in the learning database 35. Thereafter, the current position sensing operation is terminated.

Next, the position correcting operation (step S170) in the current position sensing operation will be described with reference to FIG. 3.

In the position correcting operation, as shown in FIG. 3, the nearest target is selected at step S310.

Then, at step S320, the map-matching operation is executed. In the map-matching operation, similar to the map-matching operation at step S200, the position of the vehicle 100, which is computed based on the dead-reckoning navigation path (step S140), is used as the reference.

Next, at step S330, the measurement signals from the stereo camera 19 and the radar 21 are obtained. Then, at step S340, the relative position of the measurement subject with respect to the vehicle 100 is computed.

At step S350, a road paint (e.g., a vehicle stop line or a marking of a pedestrian crosswalk) is extracted from the captured image, which is captured by the stereo camera 19, through image processing. Also, a relative position of the road paint with respect to the vehicle is computed.

The data of the extracted road paint is stored in the memory (e.g., the RAM). Furthermore, when the image processing is performed at step S350, a type of the captured object can be identified. For instance, it is possible to determine whether the captured object is a building, a utility pole, a road paint or the like. Also, in the case where the captured object is the road paint, it is possible to determine whether the road paint is the vehicle stop line, the marking of the pedestrian crosswalk or the like.

Now, with reference to FIG. 4B, a specific example will be described for illustrating the sensing of the measurement subject and the road paint through the stereo camera 19 at steps S340 and S350.

As shown in FIG. 4B, a sensing area (an image capturing area) Sb, in which the measurement subject and the road paint can be sensed through use of the stereo camera 19, is formed in front of the vehicle 100. In the case of FIG. 4B, the building B and the utility pole Ta, with which corresponding position information is associated, are located on the right front side of the vehicle 100, and a portion of this building B and a portion of the utility pole Ta are in the sensing area. Furthermore, the vehicle stop line L is also placed in the sensing area Sb.

In this state, when an image of an area (in the sensing area) around the vehicle 100 is captured with the stereo camera 19, the vehicle stop line L, which serves as the road paint, is sensed. Also, at this time, a direction of the vehicle stop line L relative to the vehicle 100 and a distance from the vehicle 100 to the vehicle stop line L (i.e., a relative position of the vehicle stop line L with respect to the vehicle 100) are sensed. Furthermore, the relative position of the utility pole Ta is simultaneously sensed.

Returning to FIG. 3, at step S360, the shape of the target and the distance from the vehicle to the target, which are stored as the target information, are compared with the shape of the measurement subject and the distance from the vehicle to the measurement subject, which are recognized by the stereo camera 19 and the radar 21.

Then, the navigation ECU 11 proceeds to step S370 where it is determined whether the target and the measurement subject coincide with each other. Here, the determination of whether the target and the measurement subject coincide with each other at step S370 is made by determining whether there exists the corresponding measurement subject, the shape of which coincides with the shape of the target on the map, within a predetermined range (e.g., within a range of 5 m) from a position, at which the measurement subject is supposed to exist.

When it is determined that the target and the measurement subject coincide with each other at step S370, the navigation ECU 11 proceeds to step S380. In contrast, when it is determined that the target and the measurement subject do not coincide with each other at step 5370, the current position correcting operation is terminated.

At step S380, the position of the vehicle is back-calculated based on the position information, which is associated with the target. Specifically, here, the position of the vehicle is determined based on the orientation of the vehicle (identified at step S140) and the relative position of the target with respect to the vehicle (i.e., the direction and the distance of the target with respect to the vehicle).

Next, the navigation ECU 11 proceeds to step S390 where the road paint identifying operation is performed, and the position correcting operation is terminated.

Here, the road paint identifying operation (step S390) of the position correcting operation will be described with reference to FIG. 5

In this road paint identifying operation, at step S510, the absolute position of the road point is computed based on the relative position of the road paint with respect to the corrected current position of the vehicle 100, which is corrected in the position correcting operation.

Then, at step S520, it is determined whether this road paint is registered as the map information in the map information database 33. Here, this determination is made by determining whether the information of this road paint is registered to be present in a predetermined range (e.g., within a range of 10 m) about the absolute position of the road paint in the map information. When it is determined that this road paint is registered at step S520, the navigation ECU 11 proceeds to step S530. In contrast, when it is determined that this road paint is not registered at step S520, the navigation ECU 11 proceeds to step S560.

Next, at step S530, the absolute position of the road paint, which is computed at step S510, is compared with the position of the registered road paint.

Then, at step S540, it is determined whether a positional difference between the absolute position of the road paint and the position of the registered road paint is within a predetermined allowable range. When it is determined that the positional difference is within the allowable range at step S540, the road paint identifying operation is terminated. In contrast, when it is determined that the positional difference is outside of the allowable range at step S540, the navigation ECU 11 proceeds to step S550. At step S550, the positional error (positional difference) is stored in the learning database 35, and the road paint identifying operation is terminated.

At step S560, the road paint, the absolute position of which is computed at step S510, is stored in the learning database 35 as a new road paint, and the current road paint identifying operation is terminated.

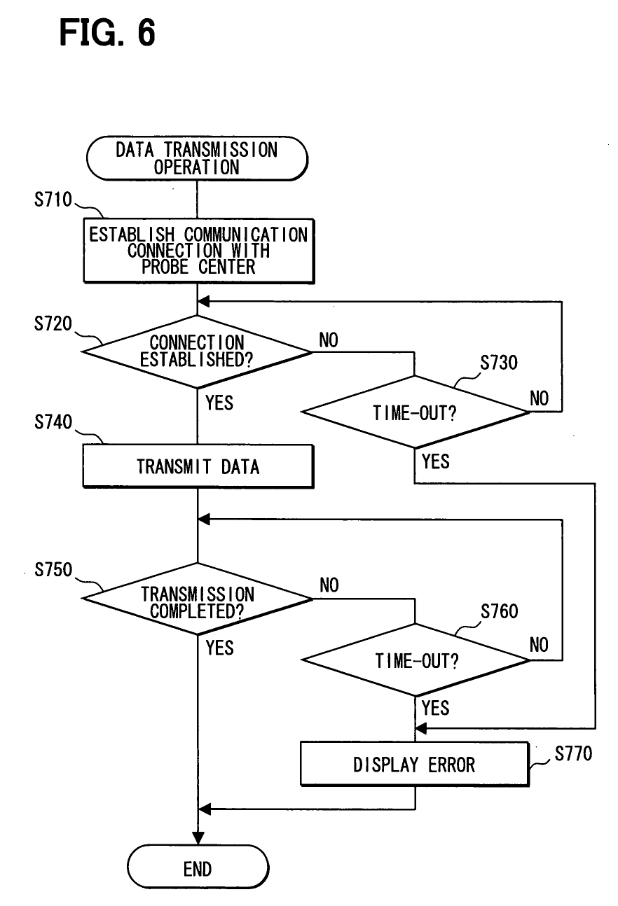

As described above, in the current position sensing operation, the various types of data, which is stored in the learning database 35, is transmissible to the probe center 50 through a communicating means, such as the cellphone 29 or the wireless LAN communication device 31. The data transmitting operation for transmitting the various types of data to the probe center 50 will be described with reference to FIG. 6. FIG. 6 is a flowchart showing the data transmitting operation, which is executed by the navigation ECU 11.

The data transmitting operation is an interrupt operation, which is started upon receiving, for example, a data transmission command signal through the manipulation device 25. First, at step S710, it is initiated to establish a communication connection with the probe center 50. With respect to the communicating means used at this time, the wireless LAN communication device 31 has a first priority. In a case where the wireless LAN communication device 31 is not operable, the cellphone 29 is used.

Next, at step S720, it is determined whether the communication connection with the probe center 50 is established. When it is determined that the communication connection with the probe center 50 is established at step S720, the navigation ECU 11 proceeds to step S740. In contrast, when it is determined that the communication connection with the probe center 50 is not established at step S720, the navigation ECU 11 proceeds to step S730.

At step S730, it is determined whether a predetermined time (e.g., 5 seconds) has elapsed since the start time of attempting to establish the communication connection with the probe center 50, i.e., whether it is time-out. When it is determined that the predetermined time (e.g., 5 seconds) has elapsed at step S730, the navigation ECU 11 proceeds to step S770. In contrast, when it is determined that the predetermined time (e.g., 5 seconds) has not elapsed at step S730, the navigation ECU 11 returns to step S720.

Next, at step S740, the data, which is stored in the learning database 35, is transmitted to the probe center 50. In this operation, it is not required to transmit all of the data stored in the learning database 35 to the probe center 50. For instance, selected data of the learning database 35, which is selected by the user through the manipulation device 25, may be transmitted to the probe center 50, or requested data, which is requested from the probe center 50, may be transmitted to the probe center 50.

Then, at step S750, it is determined whether the transmission of the data is completed. When it is determined that the transmission of the data is completed at step S750, the data transmitting operation is completed. In contrast, when it is determined that the transmission of the data is not completed at step S750, the navigation ECU proceeds to step S760.

At step S760, it is determined whether a predetermined time (e.g., 10 seconds) has elapsed since the start time of attempting to establish the communication connection with the probe center 50, i.e., whether it is time-out. When it is determined that the predetermined time (e.g., 10 seconds) has elapsed at step S760, the navigation ECU 11 proceeds to step S770. In contrast, when it is determined that the predetermined time (e.g., 10 seconds) has not elapsed at step S760, the navigation ECU 11 returns to step S750.

At step S770, an error message is displayed on the display device 23 to notify the failure of the normal data transmission.

The data transmitting operation is performed in the above described manner. The data, which is transmitted through the data transmitting operation, is analyzed and is used to form new map information or to modify the pre-existing map information. In this way, it is possible to eliminate a need for measuring the configuration of the actual road, so that less expensive map information can be provided.

In the present embodiment, the navigation system 10 corresponds to a current position sensing system and a map display system of the present invention.

The light beacon receiver 13, the GPS receiver 15 and the sensors 17 (these components may also be collectively referred to as “GPS receiver 15 and others”) corresponds to a current position sensing means of the present invention. The stereo camera 19 and the radar 21 may correspond to a relative position sensing means of the present invention. The stereo camera 19 may correspond to an image capturing means of the present invention. Furthermore, the map information database 33 may correspond to a map information storing means of the present invention. The learning database 35 may correspond to a correction amount data storing means, an error data storing means or a new data storing means of the present invention.

In the current position sensing operation (FIG. 2), the operation of step S150 may correspond to a target extracting means or a target extracting step of the present invention. The operation of step S190 may correspond to a first storing means of the present invention.

In the position correcting operation (FIG. 3), the operation of step S330 may correspond to an obtaining means or an obtaining step of the present invention. The operation of step S340 may correspond to an estimating means or an estimating step of the present invention. Furthermore, the operation of step S350 may correspond to an imaging subject sensing means of the present invention. The operation of steps S360 and S370 may correspond to a recognizing means or a recognizing step of the present invention. The operation of step S380 may correspond to a correcting means, a correcting step or a correction amount computing means of the present invention.

In the road paint identifying operation (FIG. 5), the operation of step S510 corresponds to a position determining means of the present invention, and the operation of step S520 corresponds to a stored information identifying means of the present invention. The operations of steps. S530 to S550 correspond to a second storing means of the present invention, and the operation of step S560 corresponds to a third storing means of the present invention.

The data transmitting operation (FIG. 6) is a data transmitting means of the present invention.

In the above described navigation system 10, in the current position sensing operation, the navigation ECU 11 extracts the information of the target, which is located in the sensible area (sensing area) of the stereo camera 19 and the radar 21 at the current position of the vehicle 100 sensed with the GPS receiver 15 and the others, from the map information.

In the position correcting operation, when the information of the target is extracted, the navigation ECU 11 obtains the relative position of the measurement subject, which is sensed with the stereo camera 19 and the radar 21. Then, the absolute position of the measurement subject is estimated based on the current position of the vehicle 100, which is sensed with the GPS receiver 15 and the others, and the relative position of the measurement subject.

The navigation ECU 11 computes the distance from the measurement subject to the target. When the computed distance is less than a preset threshold value, the navigation ECU 11 recognizes the measurement subject, which is sensed with the stereo camera 19 and the radar 21, as the target.

Thereafter, the navigation ECU 11 computes the absolute position of the vehicle 100 based on the position information of the target and the relative position of the target with respect to the vehicle. Then, the navigation ECU 11 corrects the current position, which is sensed with the GPS receiver 15, to the above absolute position of the vehicle 100.

Thus, in the navigation system 10 of the present embodiment, the current position of the vehicle 100 can be corrected based on the relative position of the target, with which the position information is associated. Thus, it is possible to more accurately sense the absolute position of the vehicle 100.

Furthermore, in the position correcting operation, the navigation ECU 11 computes the correction amount for the current position of the vehicle and stores the correction amount as correction amount data in the learning database 35.

Thus, the above navigation system 10 can easily analyze the correction amount of the current position of the vehicle by retrieving the stored correction amount data.

Furthermore, in the position correcting operation, the navigation ECU 11 senses the type of the imaging subject and the relative position of the imaging subject with respect to the vehicle 100 through the image processing of the image, which is captured by the stereo camera 19 and contains the imaging subject. In the road paint identifying operation, the navigation ECU 11 determines the absolute position of the imaging subject based on the corrected current position of the vehicle and the relative position of the imaging subject with respect to the corrected current position of the vehicle. Then, the navigation ECU 11 determines whether the information of this imaging subject is stored in the map information database 33. Furthermore, in the road paint identifying operation, when it is determined that the information of the imaging subject is stored in the map information database 33, the navigation ECU 11 computes a difference (an error) between the position of the imaging subject and the position of the imaging subject stored in the map information database 33 and stores this difference as error data in the learning database 35.

The navigation system 10 can record the error data, which indicates the difference between the actual position of the imaging subject and the position of the imaging subject in the map information based on the corrected current position. Thus, when the map information is corrected based on the error data, the map information can be easily corrected.

Furthermore, in the road paint identifying operation, the navigation ECU 11 of the present embodiment stores the type of the imaging subject and the absolute position of the imaging subject in the learning database 35 when it is determined that the information of the imaging subject is not stored in the map information database 33.

Thus, even when the imaging subject is not stored as the map information, the navigation system 10 can store the imaging subject as new data. Therefore, when the data is added to the map information based on the new data, the new data can be easily added to the map information.

Furthermore, in the data transmitting operation, the navigation ECU 11 externally transmits the data stored in the learning database 35.

The navigation system 10 can externally transmits the various types of data, which is stored in the learning database 35. Thus, when the map information is corrected based on this data, the map information can be corrected at the low costs.

The present invention is not limited to the above embodiment. The above embodiment may be changed in various ways without departing from scope of the present invention.

For example, in the above embodiment, the stereo camera 19 and the radar 21 are used to sense the target (the measurement subject) from the vehicle 100 side. Alternatively, position information may be outputted from a road-side device (e.g., a beacon or RFID system) to allow sensing of the position of the road-side device. Furthermore, these components may be combined in any combination.

In the present embodiment, the stereo camera 19, the radar 21 and sensors 17 are used to sense the distance from the target to the vehicle, the orientation of the vehicle and the direction of the target relative to the vehicle. The stereo camera 19 and the radar 21 are used to sense the shape of the measurement subject to determine the relative position. However, only one of these arrangements may be used.

Furthermore, in order to sense the relative position of the measurement subject with respect to the vehicle, any other structure or arrangement may be adapted. The other structure or arrangement may be as follows. For example, a distance from the vehicle to each of multiple targets (preferably three or more targets) is sensed to determine the relative position.

Also, the movable entity is not limited to the vehicle and may be changed to, for example, a cellphone, a portable computer or a PDA, in which at least the GPS receiver of the current position sensing system of the above embodiment is provided. Alternatively, the movable entity may be a human who is carrying at least the GPS receiver of the current position sensing system. Also, the map information database or the like may be provide to a remote location (e.g., the probe center, any other center, an internet computer server), and the information of the map information database may be communicated to the navigation ECU through the cellphone, the wireless LAN communication device or the like.

Additional advantages and modifications will readily occur to those skilled in the art. The invention in its broader terms is therefore not limited to the specific details, representative apparatus, and illustrative examples shown and described.

What is claimed is:

1. A current position sensing system for sensing a current position of a movable entity, comprising:
a current position sensing means for sensing an approximate current position of the movable entity;
a map information storing means for storing map information that includes information of a target, with which position information that indicates a latitude and a longitude of the target is associated;
a relative position sensing means for sensing a relative position of a measurement subject with respect to the movable entity;
a target extracting means for extracting the information of the target from the map information when the target is located within a predetermined sensing range where the measurement subject is sensible by the relative position sensing means at a time of operating the relative position sensing means at the current position sensed by the current position sensing means;
an obtaining means for obtaining the relative position of the measurement subject, which is sensed by the relative position sensing means when the information of the target is extracted by the target extracting means;
an estimating means for estimating an absolute position of the measurement subject based on the current position of the movable entity, which is sensed by the current position sensing means, and the relative position of the measurement subject, which is obtained by the obtaining means;
a recognizing means for recognizing the measurement subject, which is sensed by the relative position sensing means, as the target, which is extracted by the target extracting means, when a distance between the measurement subject, the absolute position of which is estimated by the estimating means, and the target, which is extracted by the target extracting means, is less than a predetermined threshold value; and
a correcting means for correcting the current position of the movable entity, which is sensed by the current position sensing means, to an absolute position of the movable entity, wherein the absolute position of the movable entity is computed based on the position information of the target, which is recognized by the recognizing means, and the relative position of the target, which is obtained by the obtaining means.

2. The current position sensing system according to claim 1, further comprising:
a correction amount computing means for computing a correction amount of the current position of the movable entity, which is used by the correcting means to correct the current position of the movable entity; and
a first storing means for storing the correction amount, which is computed by the correction amount computing means, in a correction amount data storing means as correction amount data.

3. The current position sensing system according to claim 1, further comprising:
an image capturing means for capturing an image around the movable entity;
an imaging subject sensing means for sensing a type of an imaging subject, which is included in the image captured by the image capturing means, and a relative position of the imaging subject with respect to the movable entity by processing the image;
a position determining means for determining an absolute position of the imaging subject based on the corrected current position of the movable entity, which is corrected by the correcting means, and the relative position of the imaging subject, which is sensed by the imaging subject sensing means;
a stored information identifying means for determining whether information of the imaging subject, the absolute position of which is determined by the position determining means, is stored in the map information storing means; and
a second storing means for storing an erroneous difference between the absolute position of the imaging subject, which is determined by the position determining means, and the position of the imaging subject, which is stored in the map information storing means, in an error data storing means as error data when the stored information identifying means determines that the information of the imaging subject is stored in the map information storing means.

4. The current position sensing system according to claim 3, further comprising a third storing means for storing the type of the imaging subject, which is sensed by the imaging subject sensing means, and the absolute position of the imaging subject, which is determined by the position determining means, in a new data storing means when the stored information identifying means determines that the information of the imaging subject is not stored in the map information storing means.

5. The current position sensing system according to claim 2, further comprising a data transmitting means for externally transmitting the data, which is stored in the storing means.

6. A map display system comprising:
the current position sensing system recited in claim 1; and
a display device that displays a map, which corresponds to the current position of the movable entity that is sensed by the current position sensing system.

7. A current position sensing method for sensing a current position of a movable entity upon execution of the current position sensing method in a current position sensing system, which includes: a current position sensing means for sensing an approximate current position of the movable entity; a map information storing means for storing map information that includes information of a target, with which position information that indicates a latitude and a longitude of the target is associated; and a relative position sensing means for sensing a relative position of a measurement subject with respect to the movable entity, the current position sensing method comprising:
extracting the information of the target from the map information when the target is located within a predetermined sensing range where the measurement subject is sensible by the relative position sensing means at a time of operating the relative position sensing means at the current position sensed by the current position sensing means;
obtaining the relative position of the measurement subject, which is sensed by the relative position sensing means when the information of the target is extracted through the extracting of the information of the target;
estimating an absolute position of the measurement subject based on the current position of the movable entity, which is sensed by the current position sensing means, and the relative position of the measurement subject, which is obtained through the obtaining of the relative position of the measurement subject;
recognizing the measurement subject, which is sensed by the relative position sensing means, as the target, which is extracted through the extracting of the information of the target, when a distance between the measurement subject, the absolute position of which is estimated through the estimating of the absolute position of the measurement subject, and the target, which is extracted through the extracting of the information of the target, is less than a predetermined threshold value; and
correcting the current position of the movable entity, which is sensed by the current position sensing means, to an absolute position of the movable entity, wherein the absolute position of the movable entity is computed based on the position information of the target, which is recognized through the recognizing of the measurement subject, and the relative position of the target, which is obtained through the obtaining of the relative position of the measurement subject.
